(19) United States
(12) Patent Application Publication
(10) Pub. No.: US 2019/0284429 A1
(43) Pub. Date: Sep. 19, 2019

(54) COATING COMPOSITION WITH IMPROVED LIQUID STAIN REPELLENCY

(71) Applicants: Dow Global Technologies LLC, Midland, MI (US); Rohm and Haas Company, Collegeville, PA (US)

(72) Inventors: Zhen Qian, Anhui (CN); Wei Cui, Shanghai (CN); Jianming Xu, Shanghai (CN); Qingwei Zhang, Shanghai (CN); Ling Li, Shanghai (CN)

(21) Appl. No.: 16/301,879

(22) PCT Filed: Jun. 17, 2016
(86) PCT No.: PCT/CN2016/086133

§ 371 Date: Nov. 15, 2018

(51) Int. Cl. C09D 133/06; C09D 5/02; C09D 4/06; C09D 7/61

(52) U.S. Cl. CPC C09D 133/064; C09D 7/61; C09D 4/06; C09D 5/022

(57) ABSTRACT

A novel coating composition comprising, by dry weight based on total dry weight of the coating composition, i) from 20% to 45% of emulsion copolymer being a copolymerization product of a monomer mixture comprising, by dry weight based on the total dry weight of the emulsion copolymer, from 30% to 80%, of ethyl acrylate; from 20% to 70%, of a vinyl monomer; and from 1% to 4%, of an ethylenically unsaturated carboxylic acid containing monomer; ii) from 0.5% to 5% of a paraffin wax; iii) from 30% to 55% of a pigment; and iv) from 0.003% to 0.5% of lithium hydroxide.

### FIELD OF THE INVENTION

The present invention relates to a coating composition with improved liquid stain repellency.

### INTRODUCTION

Stain repellency, especially liquid stain repellency, is one of the key performance requirements for coating compositions. Stain repellency is a coated surface's resistance to stains, including its resistance to being wetted by liquid stains, its resistance to being adhered by stains on the coating surface, and how easily liquid stains can be removed. In the coating industry, one of the commonly used and highly effective additives to repel liquid stains is wax. Wax tends to migrate to the surface of dry coating films and reduces the surface tension, thereby improving stain repellency.

On the other hand, in order to minimize the amount of volatile organic compounds (VOCs) in architectural coatings, in most architectural coating compositions today, alkyl acrylic monomers, such as ethyl acrylates (EAs) and ethylhexyl acrylates (EHAs), are used to make the binder component in the coating composition. However, one of the problems of using alkyl acrylic monomers (such as EAs and EHAs) in coating compositions is that their hydrophilic properties actually reduces the stain repellency effects of wax. Consequently, to compensate for the poor liquid stain repellency effect caused by acrylic monomers, more wax need to be added into the coating composition. Doing so would result in additional costs and increases the overall weight of resultant coating composition.

Thus, there is a need to develop an architectural coating composition that, when a binder is prepared by using alkyl acrylic monomers, such coating composition can achieve a performance balance in stain repellency and VOC, without having to increase the amount of wax content.

### SUMMARY OF THE INVENTION

The present invention provides a coating composition comprising, by dry weight based on total dry weight of the coating composition, i) from 20% to 45% of emulsion copolymer being a copolymerization product of a monomer mixture comprising, by dry weight based on the total dry weight of the emulsion copolymer, from 30% to 80%, of ethyl acrylate; from 20% to 70%, of a vinyl monomer; and from 1% to 4%, of an ethylenically unsaturated carboxylic acid containing monomer; ii) from 0.5% to 5% of a paraffin wax; iii) from 30% to 55% of a pigment; and iv) from 0.003% to 0.5% of lithium hydroxide.

### DETAILED DESCRIPTION OF THE INVENTION

Emulsion Copolymer The emulsion copolymer in accordance to one embodiment of the present invention comprises a combination of soft and hard monomers.

In one embodiment, the soft monomer is a C₂ to C₈ alkyl (meth)acrylate monomer and may include, for example, ethyl acrylate (EA), 2-ethylhexyl acrylate (2-EHA), n-butyl acrylate (BA), iso-butyl acrylate, octyl methacrylate, isooctyl methacrylate, decyl methacrylate (n-DMA), isodecyl methacrylate (IDMA), allylmethacrylate (ALMA), lauryl methacrylate (LMA), pentadecyl methacrylate, stearyl methacrylate (SMA), octyl acrylate, isooctyl acrylate, decyl acrylate, isodecyl acrylate, lauryl acrylate (LA), C₁₂ to C₁₅ alkyl methacrylates, cyclohexylacrylate, and cyclohexylmethacrylate. In some embodiments of the present invention, the soft monomer is a mixture of two or more soft monomers, such as, for example, a mixture of EA and EHA.

In one embodiment in accordance to the present invention, the emulsion copolymer further comprises hard vinyl monomers. Suitable hard vinyl monomers may include, for example, (meth)acrylic ester monomers including C₁ to C₃ alkyl (meth)acrylates, such as methyl methacrylate (MMA), ethyl (meth)acrylate, C₁ to C₂₀ cycloaliphatic (meth)acrylates such as isobornyl methacrylate and cyclohexyl methacrylate, vinyl aromatics such as styrene, alkylstyrenes, and alpha methyl styrene, (meth)acrylonitrile, and (meth)acrylamide or substituted (meth)acrylamides.

To improve stability in aqueous emulsion copolymer systems, it is desirable to include into the emulsion copolymer of the present invention a small amount of ethylenically unsaturated carboxylic acid group containing monomers, such as, for example, maleic acid or anhydride, itaconic acid or, preferably in some embodiments of the present invention, methacrylic acid (MAA) and acrylic acid (AA). Preferably, the ethylenically unsaturated carboxylic acid group containing monomer is added in a polymer seed or in an initial charge to a polymerization reactor, thereby limiting any adverse impact on water swelling resistance.

Suitable ethylenically unsaturated sulfur containing acid functional monomers can also be added to the emulsion copolymers and may include, for example, sodium styrene sulfonate (SSS) and (meth)acrylamidopropane sulfonate. Examples of suitable phosphorus acid monomers may include, for example, phosphoalkyl (meth)acrylates such as phosphoethyl methacrylate. The ethylenically unsaturated acids may be used in amounts of up to 1.2 wt. %, or, preferably, from 0.03 to 0.8 wt. %, based on the total dry weight of emulsion copolymer mixture, and include monomers with sulfur and phosphorus acid functional groups.

The neutralizer being used in the present invention is lithium hydroxide (LiOH). Suitable LiOH solutions can be obtained from, for example, the Chinese Chemical Reagent Co, Ltd. The amount of LiOH required to add to the emulsion during the polymerization process varies so long as the final pH level of emulsion copolymer is between 7.5 and 8.5. In one embodiment of the present invention, the amount of LiOH neutralizer is between 0.05 to 0.5 wt. %, based on the total dry weight of the emulsion copolymer mixture.

To reduce the gel content in the emulsion copolymer of the present invention (preferably keeping the gel content at around from 0.03 to 0.8 wt. %, based on the total dry weight of the emulsion copolymer mixture), one or more sulfur acid monomer, such as SSS, can be added to act as an in-process stabilizer. Such sulfur acid monomer may reduce gel formation during synthesis. Further, the addition of a sulfur acid monomer may further enhance polymerization.

Optionally, the aqueous emulsion copolymer of the present invention comprises one or more adhesion-promoting ethylenically unsaturated monomers. Other such suitable adhesion-promoting ethylenically unsaturated monomers include ureidoalkyl (meth)acrylates, ureidoalkyl (meth)acrylamides and other ureido group containing monomers.

In accordance to one embodiment of the present invention, at least one polymerizable surfactant is added into the monomer mixture of the present invention in amounts of up to 5 wt. %, preferably 0.3 to 3 wt. %, based on the total dry weight of monomer mixture, to act as stabilizing agent. Specifically, in one embodiment of the present invention, a phosphate surfactant, polyethylene glycol monotridecyl ether phosphate, such as RHODAFAC RS-610A25(P-12A) (from Rhodia) is preferably added to the monomer mixture. Other phosphate surfactants, including phosphate monomers such as phosphoethyl methacrylate (PEM), can be optionally added to achieve the same purpose.

Other suitable surfactants may include styrenated phenol sulfates, such as Hitenol™ BC-1025 (from Montello inc., Tulsa, Okla.), Aerosol NPES—930 (polyoxyethylene) nonylphenol (NP) ammonium sulfate (from Cytec Industries, Woodland Park, N.J.), ethoxylated styrenated phenol sulfates, such as E-Sperse™ RS-1596 and E-Sperse™ RS-1618 (from Ethox Chemicals, Greenville, S.C.), and sodium dodecylallyl sulfosuccinate such as TREM™ LF-40 (from Cognis, Cincinnati, Ohio).

The emulsion copolymer of the present invention can be prepared by emulsion polymerization techniques well known in the art for making emulsion copolymers from hydrophobic C₂ to C₂₄ alkyl (meth)acrylate monomers. In one example of a suitable emulsion polymerization method in accordance to the present invention, the monomer mixture is gradually added into the reaction chamber in one continuous step to form an emulsion copolymer. In another example of a suitable emulsion polymerization method in accordance to the present invention, the monomer mixture is added into the reaction chamber in two stages. While not required, the polymerization of the emulsion copolymer of the present invention can be catalyzed by a redox initiation polymerization method; the polymerization also can be polymerized by the conventional thermal initiation polymerization method.

As a result of polymerizing the above-mentioned monomers, as well as incorporating into the emulsion copolymers additives such as the LiOH neutralizer, an emulsion copolymer in accordance to one embodiment of the present invention is formed. This emulsion copolymer comprises, by dry weight based on the total dry weight of the emulsion copolymer, from 20% to 45% of emulsion copolymer being a copolymerization product of a monomer mixture comprising, by dry weight based on the total dry weight of the emulsion copolymer, from 30% to 80%, of ethyl acrylate; from 20% to 70%, of a vinyl monomer; and from 1% to 4%, of an ethylenically unsaturated carboxylic acid containing monomer.

Paraffin Wax

Coating compositions of the present invention comprises wax. The wax used in the present invention is preferably a paraffin wax, and more preferably a melted refined paraffin wax or its blend with other materials such as polyethylene wax, carnauba wax, or ethylene acrylic acid. The preferred wax has a melt point temperature of 46 to 71° C. In one embodiment of the present invention, the wax is added into the coating composition as a wax emulsion, or in another embodiment, the wax is added by dissolving into the monomers, or added by blending with other coating components.

Suitable examples of the wax include wax emulsions such as MICHEM™ Emulsion 62330 (a blend emulsion of paraffin wax and polyethylene), MICHEM Emulsion 34935 (a blend emulsion of paraffin wax and ethylene acrylic acid), MICHEM Lube 180 (a blend emulsion of paraffin wax and carnauba wax), MICHEM Emulsion 70950, and MICHEM Emulsion 71450 commercially available from Michaelman Inc., and ULTRALUBE™ E-340 commercially available from Keim Additec Surface GmbH.

The wax emulsion can be prepared by melting refined wax to a temperature above its melting point (the elevated temperature). Appropriate emulsifiers such as stearic acid, oleic acid, diethylamine ethanol, 2-amino-2-methyl-1-propanol, are then stirred into the molten wax at the elevated temperature. A base solution, such as potassium hydroxide or ammonium hydroxide, can separately be dissolved in ethylene glycol or water at the elevated temperature and then slowly added to the molten wax with an increasing agitation speed of the mixer. After the water-base mixture has been added to the molten wax, the resulting wax emulsion can be passed through a homogenizer. After homogenization, the resulting wax emulsion is cooled, for example, through a heat exchanger, and then filtered and packaged.

Pigments and Extenders

Pigments of the present invention are typically inorganic pigment particles, and preferably particulate inorganic materials which are capable of materially contributing to the opacity or hiding capability of a coating. Such materials typically have a refractive index of equal to or greater than 1.8 and include titanium dioxide (TiO₂), zinc oxide, zinc sulfide, barium sulfate, and barium carbonate. Titanium dioxide (TiO₂) is preferred.

Extenders are typically particulate inorganic materials having a refractive index of less than or equal to 1.8 and greater than 1.3 and include calcium carbonate, clay, calcium sulfate, aluminosilicate, silicate, zeolite, mica, diatomaceous earth, solid or hollow glass, and ceramic bead.

Other Coating Composition Additives

The coating composition of the present invention may further contain at least one conventional coating additives such as coalescing agents, cosolvents, surfactants, buffers, thickeners, non-thickening rheology modifiers, dispersants, humectants, wetting agents, mildewcides, biocides, plasticizers, antifoaming agents, defoaming agents, anti-skinning agents, colorants, flowing agents, crosslinkers, and anti-oxidants. The uses of these additives are common knowledge in the art.

Preparation of the Coating Composition

The preparation of the coating composition of the present invention involves the process of selecting and admixing appropriate coating ingredients in the correct proportions to provide a coating with specific processing and handling properties, as well as a final dry coating film with the desired properties.

Application of the Coating Composition

The coating composition of the present invention may be applied by conventional application methods such as brushing, roller application, and spraying methods such as air-atomized spray, air-assisted spray, airless spray, high volume low pressure spray, and air-assisted airless spray.

Suitable substrates include concrete, cement board, particle board, gypsum board, wood, stone, metal, plastics, wall paper and textile. Preferably, all the substrates are pre-primed by waterborne or solvent borne primers.

### Examples

The following examples illustrate the advantages of the present invention. Unless otherwise stated, all conditions are standard pressure and room temperature.

Table 1 below lists the key raw materials used for preparation of Examples in accordance with one embodiment of the present invention. Table 1(a) below includes the chemicals used to prepare the emulsion copolymer in accordance to the present invention. Table 1(a) also shows the acronyms for these chemicals, the function for each material, and the commercial supplier from which these materials could be obtained. Table 1(b) below shows the materials used for a coating formulation prepared using the emulsion copolymer of Table 1(a).

TABLE 1(a)
Key Raw Materials Used to Make the
Emulsion Copolymer in Examples

| Raw material | Function | Supplier |
|---|---|---|
| Polyethylene glycol monotridecyl | Surfactant | Stepan |
| ether phosphate, RS-610A25 | | Chemical |
| (P-12A) | | |
| Styrene, ST | Vinyl monomer | Dow Chemical |
| Butyl Acrylate, BA | Soft monomer | Dow Chemical |
| Methacrylic acid, MAA | Functional monomer | Dow Chemical |
| Allylmethacrylate, ALMA | Functional monomer | Dow Chemical |
| 2-Ethylhexyl acrylate, 2-EHA | Soft monomer | Dow Chemical |
| Ethyl acrylate, EA | Hard monomer | Dow Chemical |
| Sodium styrene sulfonate, SSS | Functional monomer | Dow Chemical |
| Lithium Hydroxide, LiOH | Neutralizer | Dow Chemical |
| Epoxy functional silane oligomer, | Functional monomer | Momentive |
| CoatOSil MP 200 | | |
| Sodium dodecyl (linear) benzene | Surfactant | Cognis |
| sulfonate, A-19 | | |
| Polyalkylene oxide lauryl | Functional monomer | Dow Chemical |
| methacrylate, QM-833 | | |
| Michem ® Emulsion | Parafin/Polyethylene | Michelman |
| | Emulsion | Chemical |

TABLE 1(b)
Raw Materials Used to Make the Paint
Formulation That Was Used in Examples

| Material: Trade Name (Chemical Name) | Kilogram |
|---|---|
| Grind | |
| Water | 200.00 |
| Orotan ™ 1288 (dispersant in DOW) | 2.50 |
| Triton EF-106 (APEO free surfactant in DOW) | 1.00 |
| AMP-95 (2-amino-2-methyl-1-propanol) | 0.25 |
| Cellusize QP-30000H (thickener in Union Carbide) | 2.00 |
| Dispelair CF-246 (defoamer agent in Blackburn) | 1.00 |
| Rocima 361 | 1.00 |
| Pigment: Ti-Pure R-706 ™^{,}(Titanium dioxide) | 260.00 |
| CC-700 (Calcium carbonate) | 20.00 |
| DB-80 (Kaolin) | 115.00 |
| Wax E-340 (parafin wax emulsion) | |
| Let Down | |
| Emulsion: Copolymer A (Acrylic Latex) | 320.00 |
| ROPAQUE ™ ULTRA E | 20.00 |
| Foamaster NXZ | 0.50 |
| Acrysol RM-2020 NPR | 3.00 |
| Acrysol TT-935 | 1.50 |
| AMP-95 | 0.83 |
| Kathon LX 1.5% | 1.00 |
| Water | 31.42 |
| COASOL | 19.00 |
| Total | 1000.00 |

### Testing Procedures

Liquid Stain Repellency

Liquid stain repellency evaluates the difficulty of wetting a coating surface with liquid stains. To determine the liquid stain repellency, test coatings were casted on black vinyl charts (The Leneta Co., Form P121-10N Leneta Scrub Test Panels), or on substrates of ceramic, metal, plastic and cementitious panels. The coatings were dried for seven days. The coated substrates were kept vertically so that the liquid stain drops flow from the upper to the bottom side of substrates coated with the test coating materials. Liquid stain repellency was observed and was represented by the liquid stain repellency scores shown in Table 2 below.

TABLE 2
Beading Effect Measurement Scale

| Beading | |
|---|---|
| Effect | |
| Number | Description |
| 5 | No wetting nor adhesion of water droplets observed on the |
| | coating surface |
| 4 | Wetting observed by individual small circular water droplets |
| | observed on the coating surface |
| 3 | Wetting observed by individual large water droplets observed |
| | on the coating surface |
| 2 | Wetting observed along the discrete track of water on the |
| | coating surface |
| 1 | Wetting observed along the thinner track of water on the |
| | coating surface |
| 0 | Wetting observed along the entire track of hydrophilic stains |
| | on coating surface |

Stain Removal Test

Stain removal ability was tested by using GB/T9780-2013. Thin films of test sample are casted on black vinyl scrub charts using a drawdown bar. The test samples are cured for seven days under controlled conditions, before stains are applied. Test area consists of 25 mm high and 100 mm wide. Within the test area, six types of stain colors (vinegar, black tea, ink, water black, and alcohol black, Vaseline black) are applied on the sample paint film.

Liquid stains are applied over gauze to prevent the stain material from running off from the test area. Stains stayed on the panel for two hours before excess stain is wiped off with dry tissue. The test panel is then placed on a scrub tester with a 1.5 kg weight, with a scrubbing cycle of 37 scrubs per minute. After the test panel is scrubbed for 200 cycles, it is removed from the tester, rinsed under running water, and hung up for drying.

The cleaned stain area is being evaluated by measuring the change of reflection index (X) using the formula below:

$$X = \frac{{Y}_{1}}{{Y}_{0}} \times 100$$

Y₁=Reflection index after stain removal test; Y₂=Reflection index before stain removal test.

Based on the reflection index value X, the total stain removal score R was calculated by using the following scoring table:

TABLE 3
Stain Removal Scoring Scale

| | | | | | Alcohol | Vaseline |
|---|---|---|---|---|---|---|
| R | Vinegar | Black tea | Ink | Water black | black | black |
| 10 | 99 < X ≤ 100 | 98 < X ≤ 100 | 96 < X ≤ 100 | 96 < X ≤ 100 | 95 < X ≤ 100 | 99 < X ≤ 100 |
| 9 | 98 < X ≤ 99 | 95 < X ≤ 98 | 91 < X ≤ 96 | 91 < X ≤ 96 | 89 < X ≤ 95 | 98 < X ≤ 99 |
| 8 | 97 < X ≤ 98 | 91 < X ≤ 95 | 85 < X ≤ 91 | 85 < X ≤ 91 | 82 < X ≤ 89 | 97 < X ≤ 98 |
| 7 | 96 < X ≤ 97 | 86 < X ≤ 91 | 78 < X ≤ 85 | 78 < X ≤ 85 | 74 < X ≤ 82 | 96 < X ≤ 97 |
| 6 | 95 < X ≤ 96 | 80 < X ≤ 86 | 70 < X ≤ 78 | 70 < X ≤ 78 | 65 < X ≤ 74 | 95 < X ≤ 96 |
| 5 | 93 < X ≤ 95 | 73 < X ≤ 80 | 61 < X ≤ 70 | 61 < X ≤ 70 | 55 < X ≤ 65 | 93 < X ≤ 95 |
| 4 | 90 < X ≤ 93 | 65 < X ≤ 73 | 51 < X ≤ 61 | 51 < X ≤ 61 | 44 < X ≤ 55 | 90 < X ≤ 93 |
| 3 | 86 < X ≤ 90 | 56 < X ≤ 65 | 40 < X ≤ 51 | 40 < X ≤ 51 | 32 < X ≤ 44 | 86 < X ≤ 90 |
| 2 | 81 < X ≤ 86 | 46 < X ≤ 56 | 28 < X ≤ 40 | 28 < X ≤ 40 | 19 < X ≤ 32 | 81 < X ≤ 86 |
| 1 | X ≤81 | X ≤46 | X ≤28 | X ≤28 | X ≤19 | X ≤81 |

Thereafter, the total stain removal score (R′) was calculated by using the formula below:

$${R}^{′} = \frac{{\sum }_{i = 1}^{n = 0} {R}_{i}}{n} \times 10.$$

Wherein, Ri are the stain removal scores for different stains. In China, the premium standard of stain removal is 60 points according to the new GB test method. A high stain removal score shows a better stain resistance property.

### Examples

Polymer Dispersion 1 to be Used in Inventive Coating Composition 1

326 grams of de-ionized (DI) water was charged into a glass container. Thereafter, 104.4 grams of RS-610A25 (P-12A) surfactant, 587.3 grams of styrene, 105.2 grams of 2-EHA, 760.5 grams of EA, 5 grams of SSS, 30.5 grams of MAA, and 3.8 grams of ALMA, were added into the glass container at room temperature, to form a monomer emulsion mixture.

In a five liter reactor equipped with a mechanical stirrer, thermocouple, condenser, and stainless steel feed ports, 680 grams of DI water was added and heated to 90 degree Celsius in a nitrogen atmosphere. With the DI water at 90 degree Celsius, the following materials were added into the reactor: 3.6 grams of RS-610A25 (P-12A) surfactant, 1.5 grams of sodium carbonate. The mixture being formed in the reactor is mixed for 1 minute and constitutes a seeding solution.

After the seeding solution is formed in the reactor, the monomer emulsion mixture in the container was added to the reactor at 17.4 gm/minute by using the Fluid Meter Incorporated pump. After approximately 60 minutes, or until half of the monomer emulsion mixture was added into the reactor, 15 grams of methacrylo ethylethylene urea was added.

Thereafter, the remaining monomer emulsion mixture is added into the reactor. Throughout the addition process, which lasts approximately 120 minutes, the reactor temperature was maintained at between 87 to 89 degrees Celsius. The reactor agitation rate was set at to 300 RPM.

After the monomer emulsion mixture was fed into the reactor, let the mixture set for two hours. Then, 6.7 grams of LiOH were added slowly into the reactor until the pH reaches between 7.5 to 8.5. Optionally, small amounts of biocides and defoamers were added into the reactor.

Thereafter, the cooling process of the reactor begins. Once the reactor has cooled to 30 degrees Celsius, the contents of the reactor was discharged and filtered through a 150 micron (#100 Mesh) sieve and a 45 micron (#325 Mesh) sieve. The resulting emulsion has the following properties: 50.5% solids, pH at 7.8, and particle size of 135 nm.

After the emulsion polymer was prepared, it was incorporated into a coating composition formulation by mixing with the materials listed in Table 1(b).

Polymer Dispersion 2 to be Used in Inventive Coating Composition 2

326 grams of deionized (DI) water was charged into a glass container. Thereafter, 104.4 grams of RS-610A25 (P-12A) surfactant, 542.2 grams of styrene, 911.3 grams of EA, 5 grams of SSS, 30.5 grams of MAA, and 3.8 grams of ALMA, were added into the glass container at room temperature, to form a monomer emulsion mixture.

In a five liter reactor equipped with a mechanical stirrer, thermocouple, condenser, and stainless steel feed ports, 680 grams of DI water was added and heated to 90 degree Celsius in a nitrogen atmosphere. With the DI water at 90 degree Celsius, the following materials were added into the reactor: 3.6 grams of RS-610A25 (P-12A) surfactant, 1.5 grams of sodium carbonate. The mixture being formed in the reactor is mixed for 1 minute and constitutes a seeding solution.

After the seeding solution is formed in the reactor, the monomer emulsion mixture in the container was added to the reactor at 17.4 gm/minute by using the Fluid Meter Incorporated pump. After approximately 60 minutes, or until half of the monomer emulsion mixture was added into the reactor, 15 grams of methacrylo ethylethylene urea was added.

Thereafter, the remaining monomer emulsion mixture is added into the reactor. Throughout the addition process, which lasts approximately 120 minutes, the reactor temperature was maintained at between 87 to 89 degrees Celsius. The reactor agitation rate was set at to 300 RPM.

After the monomer emulsion mixture was fed into the reactor, let the mixture set for two hours. Then, 6.7 grams of LiOH were added slowly into the reactor until the pH reaches between 7.5 to 8.5. Optionally, small amounts of biocides and defoamers were added into the reactor.

Thereafter, the cooling process of the reactor begins. Once the reactor has cooled to 30 degrees Celsius, the contents of the reactor was discharged and filtered through a 150 micron (#100 Mesh) sieve and a 45 micron (#325 Mesh) sieve. The resulting emulsion has the following properties: 50.5% solids, pH at 7.8, and particle size of 135 nm.

After the emulsion polymer was prepared, it was incorporated into a coating composition formulation by mixing with the materials listed in Table 1(b).

Polymer Dispersion 3 to be Used in Comparative Coating Composition 1

An emulsion polymer prepared using steps substantially similar to those described in Polymer dispersion 1 above, except that instead of adding LiOH to neutralize the polymerized monomers, 6.55 gm of sodium oxide (NaOH) was used.

Polymer Dispersion 4 to be Used in Comparative Coating Composition 2

An emulsion polymer prepared using steps substantially similar to those described in Polymer dispersion 2 above, except that instead of adding LiOH to neutralize the polymerized monomers, 6.55 gm of sodium oxide (NaOH) was used.

Coating Compositions

Coating compositions containing Polymer Dispersions 1-4 was prepared using the ingredients listed in Table 1(b). Grind materials were mixed using a high speed Cowles disperser, and letdown materials were added using a conventional lab mixer. Appropriate adjustment of weights of ACRYSOL™ TT-935 rheology modifier and AMP-95 base in letdown process was done such that the resulting coating had a KU viscosity of 90 to 95, and a pH of 8.5 to 9.0. The PVC value for each Inventive Coating Compositions 1 and 2, and Comparative Coating Compositions 1 and 2, is 50%. The volume solids value for each Inventive Coating Compositions 1 and 2, and Comparative Coating Compositions 1 and 2, is 44%.

### Results

Table 4 below compares the evaluation results for the analyses that have been performed on Inventive Coating Compositions 1 and 2 (compositions of the present invention) and Comparative Coating Compositions 3 and 4.

TABLE 4
Test Results

| | Inventive | Inventive | Comparative | Comparative |
|---|---|---|---|---|
| | Coating | Coating | Coating | Coating |
| | Composition 1 | Composition 2 | Composition 1 | Composition 2 |
| Emulsion copolymer | 50 EA/39 ST/7 | 60 EA/36 ST/2 | 50 EA/39 ST/7 | 60 EA/36 ST/2 |
| weight distribution | EHA/2 MAA | MAA | EHA/2 MAA | MAA |
| (based on total dry | | | | |
| weight of binder) | | | | |
| Neutralizer used | LiOH | LiOH | NaOH | NaOH |
| Wt. % of wax | 5% | 5% | 5% | 5% |
| included in the | | | | |
| coating composition | | | | |
| Beading Effect | 5 | 4 | 2 | 2 |
| Score | | | | |
| Stain Score | 67 | 63 | 63 | 63 |

The test results in Table 4 show that all of the inventive and comparative samples contain the same amount of paraffin wax. Table 4 further shows that Inventive Coating Compositions 1 and 2, which contain binders that comprise ethyl acrylate and ethylhexyl acrylate, and used LiOH as neutralizing agent, show significantly better beading effects than Comparative Coating Compositions 1 and 2, which contain the same binders but used NaOH as neutralizing agent. Therefore, the test results show that when LiOH is used as neutralizing agent in combination with a binder made with alkyl acrylic monomers, the resulting coating composition would have improved stain repellency.

What is claimed is:

1. A coating composition comprising, by dry weight based on total dry weight of the coating composition,
i) from 20% to 50% of emulsion comprising, by dry weight based on the total dry weight of the emulsion copolymer, from 30% to 80%, of ethyl acrylate; from 30% to 80%, of a hard vinyl monomer; and from 0% to 40%, of a carboxylic acid monomer or a salt thereof;
ii) from 0.5% to 5% of a paraffin wax;
iii) from 30% to 55% of a pigment; and
iv) from 0.003% to 0.5% of lithium hydroxide.

2. The coating composition of claim 1, wherein the emulsion copolymer further comprises, by dry weight based on the total dry weight of the emulsion polymer, up to 20% of 2-ethylhexyl acrylate.

3. The coating composition of claim 1, wherein the hard vinyl monomer is styrene.

4. The coating composition of claim 1, wherein the emulsion copolymer further comprises, by dry weight based on the total dry weight of the emulsion polymer, up to 1% of structural units of an ethylenically unsaturated sulfur containing acid functional monomer.

5. The coating composition of claim 4, wherein the ethylenically unsaturated sulfur containing acid functional monomer is sodium styrene sulfonate.

6. The coating composition of claim 1, wherein the emulsion copolymer further comprises, by dry weight based on the total dry weight of the emulsion polymer, from 1% to 4% of a stabilizer monomer.
